(19) United States
(12) Patent Application Publication
(10) Pub. No.: US 2012/0263849 A1
(43) Pub. Date: Oct. 18, 2012

(54) BITTERNESS SUPPRESSION METHOD

(75) Inventor: Atsushi TSUJI, Sumida-ku (JP)

(73) Assignee: KAO CORPORATION, Chuo-ku (JP)

(21) Appl. No.: 13/253,481

(22) Filed: Oct. 5, 2011

(30) Foreign Application Priority Data
Oct. 5, 2010 (JP) 2010-225442

(51) Int. Cl. A23L 1/221; A23F 3/16; A23L 2/56

(52) U.S. Cl. 426/538

(57) ABSTRACT

Provided is a bitterness suppression method capable of effectively suppressing an unpleasant bitterness. Also, provided is a bitterness suppression method including incorporating methyl salicylate in a composition having a bitterness.

### FIELD OF THE INVENTION

The present invention relates to a bitterness suppression method.

### BACKGROUND OF THE INVENTION

As foods and drinks having a bitterness, for example, drinks such as coffee and green tea, beans such as soybeans and azuki beans, vegetables such as bell peppers, and citrus such as grapefruits are known. These foods and drinks contain, for example, caffeine, catechin, saponin, flavonoid, limonin, or naringin as a bitter component.

It should be pointed out that bitterness is one of the tastes, and while a slight hint of bitterness is effective in enhancing the palatability, an overly strong bitterness will cause an unpleasant feeling or a disgust feeling.

As means for suppressing such an unpleasant bitterness, for example, a method of adding protamine and/or a salt thereof (Patent Document 1), a method of adding a certain amount of sugar alcohols (Patent Documents 2 and 3), a method of adding a certain amount of cyclodextrin (Patent Document 4), and a method of adding sugarcane-derived extracts (Patent Document 5) are proposed.

### PRIOR ART DOCUMENT

### Patent Document

[Patent Document 1] JP-A-6-153875
[Patent Document 2] JP-A-7-274829
[Patent Document 3] JP-A-11-253102
[Patent Document 4] JP-A-10-4919
[Patent Document 5] JP-A-2002-34471

### SUMMARY OF THE INVENTION

The present inventions are as provided in [1] to [8] below.

[1] A bitterness suppression agent containing methyl salicylate as an active component.
[2] A bitterness suppression method including incorporating methyl salicylate in a composition having a bitterness.
[3] A drink containing a bitter component and 0.05 to 10 ppm by weight of methyl salicylate.
[4] A drink containing (A) 0.03 to 0.6% by weight of non-polymer catechins and (B) 0.05 to 10 ppm by weight of methyl salicylate.
[5] A bitterness suppression method for a drink containing a bitter component, including adding 0.05 to 10 ppm by weight of methyl salicylate to the drink containing a bitter component.
[6] Use of methyl salicylate for suppression of bitterness in a drink containing a bitter component.
[7] The use according to the aforementioned [6], wherein the bitter component is non-polymer catechins.
[8] A method for producing a drink having a suppressed bitterness of non-polymer catechins, including the step of incorporating into, (A) 0.03 to 0.6% by weight of the non-polymer catechins, (B) 0.05 to 10 ppm by weight of methyl salicylate.

### DESCRIPTION OF THE INVENTION

Recently, along with diversification of consumers' preferences and an increasing health consciousness, development of a bitterness suppression agent which is a naturally derived component capable of effectively suppressing an unpleasant bitterness has been demanded.

Accordingly, the present invention is to provide a bitterness suppression method which effectively suppresses an unpleasant bitterness. Also, the present invention is to provide a drink having a suppressed unpleasant bitterness derived from a bitter component.

The present inventors have conducted various studies in view of the aforementioned problems. As a result, they have found that methyl salicylate is effective in suppressing an unpleasant bitterness.

The present invention can effectively suppress an unpleasant bitterness. Also, the method for suppressing a bitterness/astringency according to the present invention is highly safe, and thus can be applied to the fields of food and drink, pharmaceutical product and quasi drug.

### (Bitterness Suppression Agent)

The bitterness suppression agent of the present invention contains methyl salicylate as an active component.

Methyl salicylate is contained in abundance in plants belonging to the genus Betula of the family Betulaceae (such as Betula grossa), Gaultheria miqueliana belonging to the family Ericaceae, plants belonging to the family Pyrolaceae, and the like. While it has been long known as an external analgesic and anti-inflammatory drug, it has also been used as a fragrance for its menthol-like refreshing aroma. However, there has been no report of the conventional bitterness suppressing effect of methyl salicylate, and thus the bitterness suppressing effect of methyl salicylate could have not been anticipated at all.

Methyl salicylate may be a naturally derived product, which is obtained by extraction from methyl salicylate-containing plants, followed by separation by column chromatography, etc., or a chemically synthesized product, or further, a commercially available product.

A known method may be adopted for the extraction method, and examples thereof include a method of extraction with water, an organic solvent, or an aqueous solution of an organic solvent, a method of extraction by steam distillation, and a method of supercritical extraction. It is noted that examples of the organic solvent include alcohols such as ethanol, ketones such as acetone, esters such as ethyl acetate, ethers such as tetrahydrofuran, polyether such as polyethylene glycol, hydrocarbons such as toluene and petroleum ether. One of these organic solvents or a combination of two or more of them may be used.

No particular limitation is imposed on the part of a plant to be used for extraction, and any part such as a flower, a leaf, a stem, a root, and the whole plant may be appropriately selected and used. These parts may be used singly, or a combination of two or more of them may also be used. Also, when extraction is carried out, the plant may be subjected to a pre-treatment such as crushing, cutting, and drying.

The bitterness suppression agent of the present invention may be applied to any substance without any particular limitation as long as the substance contains a bitter component. It is preferably applied to a composition having a bitterness having a bitterness intensity of 7 or less based on the quinine sulfate standard solution. The “bitterness intensity based on the quinine sulfate standard solution” as used in the present specification refers to, in an sensory test based on 10 standard solutions each adjusted in advance to have different levels of bitterness intensity which differ by equal increments using quinine sulfate (refer to Table 1 of Example, Indow, T, Perception & Psychophysics, Vol. 5 (1969), pp. 347 to 351), the bitterness intensity of the quinine sulfate standard solution which was recognized by a subject, among those standard solutions, to have an equal bitterness intensity to the test substance. More specifically, the bitterness intensity is determined by the following procedure. Firstly, five healthy people having a normal sense of taste are assigned to be subjects, and each subject holds each quinine sulfate standard solution in the mouth in ascending order of concentration to memorize the bitterness intensity. Subsequently, each subject holds a test substance in the mouse to recognize the degree of bitterness, and from among the quinine sulfate standard solutions, determines one having the closest bitterness level. Then, the values of bitterness intensity determined by each subject are averaged out and provided as the bitterness intensity of the test substance. It is noted that the smaller the bitterness intensity, the weaker the bitterness.

In the present invention, the bitterness intensity of a composition having a bitterness is preferably 7 or less, and more preferably 6 or less, based on the quinine sulfate standard solution. Also, no particular limitation is imposed on the lower limit of the bitterness intensity, and it is preferably 3, and more preferably 4.

Examples of such a composition having a bitterness include oral pharmaceutical products, oral quasi drugs, foods, drinks and the like, which have the bitterness.

Examples of the bitter component in an oral pharmaceutical product include strychnine, quinine, papaverine, berberine, promethazine, brucine, propranolol, chlorpromazine and the like. These medicaments may be in the form of acid addition salts, and examples thereof include mineral acid salts such as hydrochlorides, nitrates, sulfates, and carbonates and organic acid salts such as acetates and citrates.

Examples of the oral quasi drug include tooth pastes, mouthwash, mouth rinse and the like. Examples of the bitter component in an oral quasi drug include surfactants such as sodium alkyl sulfate and sodium monoalkyl phosphate, fragrances such as menthol, linalool, phenyl ethyl alcohol, and geraniol, and antimicrobial agents such as methylparaben and propylparaben. It is noted that no particular limitation is imposed on the dosage form of the oral pharmaceutical product and the oral quasi drug, and a known dosage form may be adopted.

Examples of the food and drink having a bitterness are as follows:

citrus fruits such as grapefruits, oranges, and lemons or fruit juice obtained from these fruits; vegetables such as tomatoes, bell peppers, celeries, gourds, carrots, potatoes, and asparaguses or vegetable extracts or vegetable juice obtained from these vegetables; seasonings such as sauce, soy sauce, miso (i.e., Japanese fermented soybean paste), chili pepper, and flavor enhancer for savoriness; soy food such as soy milk; emulsified food such as cream, dressings, mayonnaise, and margarine; processed seafood products such as fish meat, minced fish, fish eggs; nuts such as peanut; fermented food such as natto (i.e., fermented soybeans); edible meat or processed meat products; drinks such as beer, coffee, cocoa, green tea, black tea, oolong tea, soft drinks, and functional drinks; pickled foods; noodles; soups including powder soup; dairy products such as cheese and milk; breads and cakes; and confectionery such as snacks, biscuits, snacks made from rice, chewing gum, chocolate, and candies.

Examples of the bitter component in these foods and drinks include amino acids, polyphenols, caffeine, peptides, saponin, limonin, naringin, oligosaccharides and the like.

Examples of the amino acid include leucine, isoleucine, phenylalanine and the like.

Representative examples of the polyphenols include flavonoid, chlorogenic acids and the like. Examples of the flavonoid include the non-polymer catechins, tannin and the like. It is noted that the content of tannin can be obtained in terms of an amount of gallic acid by the ferrous tartrate method using ethyl gallate as a standard solution. Also, the “chlorogenic acids” is a generic term collectively referring to monocaffeoylquinic acid such as 3-caffeoylquinic acid, 4-caffeoylquinic acid, and 5-caffeoylquinic acid, monoferulaquinic acid such as 3-ferulaquinic acid, 4-ferulaquinic acid, and 5-ferulaquinic acid, and dicaffeoylquinic acid such as 3,4-dicaffeoylquinic acid, 3,5-dicaffeoylquinic acid, and 4,5-dicaffeoylquinic acid. The content of chlorogenic acids is defined based on the sum of the aforementioned nine chlorogenic acids, and may be measured by high performance liquid chromatography (HPLC) using a UV-VIS detector.

The foods and drinks containing these bitter components generally have a bitterness intensity of 7 or less. Among them, drinks containing a bitter component (for example, green tea drinks, oolong tea drinks, and black tea drinks) are preferable. Also, as the bitter component, one containing 0.03 to 0.6% by weight of polyphenols, particularly, the non-polymer catechins, is preferable.

The amount of the bitterness suppression agent of the present invention to be used may be appropriately selected depending on the kind of bitter component and the bitterness intensity. When it is used for a composition having a bitterness having a bitterness intensity of 7 or less based on the quinine sulfate standard solution, for example, it is added in an amount of, as the amount of active component, preferably 0.05 ppm by weight or more, more preferably 0.1 ppm by weight or more, even more preferably 0.2 ppm by weight or more, and even more preferably 0.3 ppm by weight or more relative to the total weight of the bitter composition from the viewpoint of the bitterness-suppressing effect. Also, the upper limit is, as the amount of active component, preferably 10 ppm by weight, more preferably 5 ppm by weight, and even more preferably 2 ppm by weight relative to the total weight of the bitter composition since it does not affect the taste and flavor and the like.

It is noted that methyl salicylate as an active component may be quantitated by gas chromatograph-mass spectrometry by the following procedure.

Four grams of a sample is weighed, to which water was added up to 20 mL. To this, 10 mL of diethyl ether and 8 g of sodium chloride are added, followed by shaking, and the diethyl ether layer is collected and analyzed under the following operational conditions.

Gas chromatograph-mass spectrometer: 6890N/5975B inertXL (the product of AGILENT TECHNOLOGIES, INC.)

column: DB-WAX (the product of AGILENT TECHNOLOGIES, INC., a diameter of 0.25 mm×30 m, membrane thickness 0.25 μm)

Introduction system: splitless

Temperature: 220° C. at the sample injection port/60° C. in the column (keep for 5 min)→raise at 10° C./min→220° C.

Gas flow rate: helium (carrier gas) 1 mL/min

Ion source temperature: 230° C.

Ionization method: EI

Set mass number: m/z=120, 152

### (Drink)

The drink of the present invention contains (A) non-polymer catechins and (B) methyl salicylate. The “non-polymer catechins” as used in the present specification is a generic term collectively referring to non-epicatechins which include catechin, gallocatechin, catechin gallate, and gallocatechin gallate and epicatechins which include epicatechin, epigallocatechin, epicatechin gallate, and epigallocatechin gallate. The present invention may contain at least one of them. It should be noted that the content of the non-polymer catechins is defined based on the sum of the aforementioned eight non-polymer catechins, and may be measured in accordance with the methods described in Examples to be presented below.

The content of (A) the non-polymer catechins in the drink of the present invention is 0.03 to 0.6% by weight; and, from the viewpoint of further suppression of bitterness, the drink of the present invention contains preferably 0.05 to 0.3% by weight, and more preferably 0.1 to 0.2% by weight of (A) the non-polymer catechins.

Meanwhile, the content of (B) methyl salicylate in the drink of the present invention is 0.05 to 10 ppm by weight; and, from the viewpoint of further suppression of bitterness, the lower limit is preferably 0.1 ppm by weight, more preferably 0.2 ppm by weight, and even more preferably 0.3 ppm by weight, while the upper limit is preferably 7 ppm by weight, more preferably 5 ppm by weight, and even more preferably 2 ppm by weight since it does not affect the taste and flavor and the like.

Also, the lower limit of the content weight ratio of (B) methyl salicylate to (A) the non-polymer catechins [(B)/(A)] is preferably 0.4×10⁻⁵, more preferably 0.9×10⁻⁵, even more preferably 1.5×10⁻⁵, and even more preferably 1.8×10⁻⁵ from the viewpoint of further suppression of bitterness. Meanwhile, the upper limit is preferably 0.001, more preferably 0.0007, and even more preferably 0.0004 so as not to affect the flavor, etc.

The drink of the present invention may be either tea drinks or non-tea drinks. Examples of the tea drink include green tea drinks, oolong tea drinks, and black tea drinks. Also, examples of the non-tea drink include non-alcoholic drinks such as fruit juice, vegetable juice, sport drinks, isotonic drinks, enhanced water, bottled water, near water, coffee drinks, energy drinks, and beauty drinks and alcoholic drinks such as beer, wine, sake, plum liquor, low-malt beer, whisky, brandy, distilled spirit, rum, gin, and liqueurs.

Additives such as sweeteners, acidulants, antioxidants, organic acids, organic acid salts, inorganic acids, inorganic acid salts, inorganic salts, cyclic oligosaccharides, colorants, emulsifiers, preservatives, seasonings, gum, oil, vitamins, fruit juice, vegetable extracts, floral nectar essence, pH adjusters, and quality stabilizers may be incorporated singly or in combinations of two or more to the drink of the present invention as needed. The amount of these additives to be incorporated may be appropriately set within such a range that does not impair the objects of the present invention.

The pH (20° C.) of the drink of the present invention is preferably 2 to 7.5, more preferably 2.5 to 7, and even more preferably 3 to 6.5 from the viewpoint of the taste and the stability of the non-polymer catechins.

The drink of the present invention can be produced by, for example, mixing at least one selected from a catechin preparation and a purified catechin preparation with methyl salicylate, and adjusting the concentration of each of (A) the non-polymer catechins and (B) methyl salicylate.

Examples of the “catechin preparation” used in the production of the drink of the present invention include an extract solution which is obtained from tea leaves selected from unfermented tea, semi-fermented tea, and fermented tea using hot water or a water-soluble organic solvent by kneader extraction, column extraction, and the like. Also, a concentrated extract solution having a higher concentration of the non-polymer catechins, which is obtained by removing a part of the solvent from the extract solution, may be used. Examples of the form of the catechin preparation include various forms such as a solid, an aqueous solution, and a slurry. A commercial product may be used as the catechin preparation, and examples thereof include “POLYPHENON” supplied by MITSUI NORIN CO., LTD., “THEA-FLAN” supplied by ITO EN, LTD., “SUNPHENON” supplied by TAIYO KAGAKU CO., LTD and the like. Also, examples of the unfermented tea include green teas such as sencha, bancha, tencha, kamairicha, kukicha, bocha, and mecha. Examples of the semi-fermented tea include oolong teas such as tekkannon, shikishu, ogonkei, and buigancha. Further, examples of the fermented tea include black teas such as Darjeeling, Assam, and Sri Lanka. One of these teas or a combination of two or more of them may be used.

Also, examples of the purified catechin preparation include ones prepared by any of the methods (i) to (iv) shown below or a combination of two or more of these methods.

(i) A method including suspending a catechin preparation into water, a water-soluble organic solvent (such as ethanol), or a mixture of water and a water-soluble organic solvent (hereinbelow, referred to as an “aqueous solution of an organic solvent”) and removing the resulting precipitate, followed by distillation of the solvent (for example, JP-A-2004-147508 and JP-A-2004-149416).
(ii) A method including bringing a catechin preparation into contact with at least one adsorbent selected from activated carbon, acid clay, and activated clay (for example, JP-A-2007-282568).
(iii) A method including allowing a catechin preparation to adsorb onto a synthetic adsorbent, and after that, bringing an aqueous solution of an organic solvent into contact with the synthetic adsorbent to detach the non-polymer catechins (for example, JP-A-2006-160656).
(iv) A method including allowing a catechin preparation to adsorb onto a synthetic adsorbent, after that, bringing an aqueous solution of an organic solvent or a basic aqueous solution (such as an aqueous solution of sodium hydroxide) into contact with the synthetic adsorbent to detach the non-polymer catechins, and then bringing the resulting detached solution into contact with activated carbon (for example, JP-A-2008-079609).

In the aforementioned methods (i) to (iv), a catechin preparation which has been subjected to tannase treatment may also be used as the catechin preparation. The “tannase treatment” as used herein refers to bringing a catechin preparation into contact with an enzyme having a tannase activity. By doing so, it is possible to reduce the ratio of gallate forms in the non-polymer catechins. It is noted that for a specific operational method in the tannase treatment, a known method may be adopted, and examples of such a method include one described in JP-A-2004-321105. As the catechin preparation used in the present invention, one in which the ratio of gallate forms in the non-polymer catechins (hereinbelow, may simply be referred to as a “ratio of the gallate form”) is 5 to 70% by weight is preferable, and one in which the above ratio is 10 to 60% by weight is more preferable.

Also, the drinks according to the present invention can be provided in a conventional packaging containers such as molded containers made of polyethylene terephthalate as a principal component (so-called PET bottle), metal cans, paper containers combined with metal films or plastic films, glass bottles and the like. Further, for example, after a container such as a metal can is filled therewith, when heat sterilization is feasible, the drink according to the present invention can be produced under the sterilization conditions as stipulated in the laws and regulations to be applied (Food Sanitation Act in Japan). For those for which retort sterilization is not feasible such as PET bottles and paper containers, a process may be adopted such that the drink is sterilized beforehand at a high temperature for short time under similar sterilization conditions to those described above, for example, by using a plate-type heat exchanger and the like, is cooled to a particular temperature, and is then filled in containers. Also, under aseptic environment, other components may be added to the drink-filled containers. Further, operations such as bringing pH back to neutral under aseptic environment after carrying out heat sterilization under acidic conditions and bringing pH back to acidic under aseptic environment after carrying out heat sterilization under neutral conditions may also be performed.

More specifically, the present invention includes the following [1] to [7-3].

[1] A bitterness suppression agent containing methyl salicylate as an active component.
[2-1] A bitterness suppression method including incorporating methyl salicylate to a composition having a bitterness.
[2-2] The bitterness suppression method according to the aforementioned [2-1], wherein a bitterness intensity of the composition having the bitterness is 7 or less, preferably 3 to 7, more preferably 4 to 6, based on a quinine sulfate standard solution.
[2-3] The bitterness suppression method according to the aforementioned [2-1] or [2-2], wherein an added amount of methyl salicylate is 0.05 ppm by weight or more, preferably 0.1 ppm by weight or more, more preferably 0.2 ppm by weight or more, even more preferably 0.3 ppm by weight or more, relative to a total weight of the composition having the bitterness.
[2-4] The bitterness suppression method according to any one of the aforementioned [2-1] to [2-3], wherein the added amount of methyl salicylate is 0.05 to 10 ppm by weight, preferably 0.1 to 5 ppm by weight, more preferably 0.2 to 5 ppm by weight, even more preferably 0.3 to 2 ppm by weight, relative to a total weight of the composition having the bitterness.
[2-5] The bitterness suppression method according to any one of the aforementioned [2-1] to [2-4], wherein the composition having the bitterness is a food and drink.
[2-6] The bitterness suppression method according to any one of the aforementioned [2-1] to [2-4], wherein the composition having the bitterness is a drink.
[3-1] A drink including a bitter component and 0.05 to 10 ppm by weight of methyl salicylate.
[3-2] The drink according to the aforementioned [3-1], wherein the bitter component is non-polymer catechins.
[3-3] The drink according to the aforementioned [3-1] or [3-2], wherein a content of methyl salicylate is 0.1 to 5 ppm by weight, preferably 0.2 to 5 ppm by weight, more preferably 0.3 to 2 ppm by weight.
[4-1] A drink including the following components (A) and (B): (A) 0.03 to 0.6% by weight of non-polymer catechins; and (B) 0.05 to 10 ppm by weight of methyl salicylate.
[4-2] The drink according to the aforementioned [4-1], wherein a content of (A) the non-polymer catechins is 0.05 to 0.3% by weight, more preferably 0.1 to 0.2% by weight.
[4-3] The drink according to the aforementioned [4-1] or [4-2], wherein a content of (B) methyl salicylate is 0.1 to 5 ppm by weight, more preferably 0.2 to 5 ppm by weight, even more preferably 0.3 to 2 ppm by weight.
[4-4] The drink according to any one of the aforementioned [4-1] to [4-3], wherein a content weight ratio of (B) methyl salicylate to (A) the non-polymer catechins [(B)/(A)] is 0.4×10⁻⁵ to 0.001, preferably 0.9×10⁻⁵ to 0.001, more preferably 1.5×10⁻⁵ to 0.0007, even more preferably 1.8×10⁻⁵ to 0.0004.
[5-1] A bitterness suppression method for a drink containing a bitter component, including adding 0.05 to 10 ppm by weight of methyl salicylate to the drink containing the bitter component.
[5-2] The bitterness suppression method for the drink according to the aforementioned [5-1], wherein the bitter component is polyphenols.
[5-3] The bitterness suppression method for the drink according to the aforementioned [5-1] or [5-2], wherein the bitter component is non-polymer catechins.
[5-4] The bitterness suppression method for the drink according to the aforementioned [5-3], wherein the drink contains 0.03 to 0.6% by weight, more preferably 0.05 to 0.3% by weight, even more preferably 0.1 to 0.2% by weight of the non-polymer catechins.
[5-5] The bitterness suppression method for the drink according to any one of the aforementioned [5-1] to [5-4], wherein an added amount of methyl salicylate is 0.1 to 5 ppm by weight, more preferably 0.2 to 5 ppm by weight, even more preferably 0.3 to 2 ppm by weight.
[6-1] Use of methyl salicylate for suppression of bitterness in a drink containing a bitter component.
[6-2] The use of methyl salicylate according to the aforementioned [6-1], wherein 0.05 to 10 ppm by weight of methyl salicylate is used.
[6-3] The use of methyl salicylate according to the aforementioned [6-1] or [6-2], wherein the bitter component is non-polymer catechins.
[7-1] A method for producing a drink having a suppressed bitterness of non-polymer catechins, including the step of incorporating into, (A) 0.03 to 0.6% by weight of the non-polymer catechins, (B) 0.05 to 10 ppm by weight of methyl salicylate.
[7-2] The method for producing the drink having the suppressed bitterness of non-polymer catechins according to the aforementioned [7-1], wherein a content of (A) the non-polymer catechins is 0.05 to 0.3% by weight, more preferably 0.1 to 0.2% by weight.
[7-3] The method for producing the drink having the suppressed bitterness of non-polymer catechins according to the aforementioned [7-1] or [7-2], wherein a content of the methyl salicylate is 0.1 to 5 ppm by weight, more preferably 0.2 to 5 ppm by weight, even more preferably 0.3 to 2 ppm by weight.

### EXAMPLE

### Evaluation of Bitterness

Five subjects conducted a sensory test with reference to the bitterness level of each test solution using the quinine sulfate standard solutions shown in the following Table 1 as a standard, and an average score of the evaluation scores submitted by each subject was calculated.

TABLE 1
<Quinine sulfate standard solution>

| | Concentration of |
|---|---|
| Bitterness | quinine sulfate |
| intensity | (g/100 mL aq.) |
| 1 | 0.00022 |
| 2 | 0.00048 |
| 3 | 0.00090 |
| 4 | 0.00150 |
| 5 | 0.00230 |
| 6 | 0.00370 |
| 7 | 0.00580 |
| 8 | 0.00940 |
| 9 | 0.01500 |
| 10 | 0.02450 |

### Examples 1 to 3

Bitterness suppression agents were incorporated in 0.00230 g/100 mL quinine sulfate standard solutions (bitterness intensity 5) at the ratios as shown in Table 2 to prepare test solutions, and after that the sensory test was conducted. It is noted that as the bitterness suppression agent, commercially available methyl salicylate (Methyl salicylate Sigma Ultra, the product of SIGMA-ALDRICH CORPORATION) was used.

### Comparative Example 1

A test solution was prepared by the same operation as in Example 1, except for incorporating β-cyclic oligosaccharide at the ratio as shown in Table 2 instead of methyl salicylate, and the sensory test was conducted. The results thus obtained are shown in Table 2.

### Comparative Example 2

A test solution was prepared by the same operation as in Example 1, except for incorporating cyclic oligosaccharide at the ratio as shown in Table 2 instead of methyl salicylate, and the sensory test was conducted. The results thus obtained are shown in Table 2.

TABLE 2

| | | Added amount | |
|---|---|---|---|
| | | of bitterness | |
| | | suppression | |
| | | agent | |
| | Kind of bitterness | (ppm by | Bitterness |
| | suppression agent | weight) | intensity |
| Standard | — | — | 5 |
| Example 1 | Methyl salicylate¹⁾ | 0.1 | 4.3 |
| Example 2 | Methyl salicylate¹⁾ | 0.5 | 4.2 |
| Example 3 | Methyl salicylate¹⁾ | 1 | 3.7 |
| Comparative | β-Cyclodextrin²⁾ | 500 | 4.7 |
| Example 1 | | | |
| Comparative | Cyclic | 5000 | 4.7⁴⁾ |
| Example 2 | oligosaccharaide³⁾ | | |

¹⁾Methyl salicylate Sigma Ultra, purity 99%, the product of SIGMA-ALDRICH CORPORATION
²⁾Celldex B-100, the product of NIHON SHOKUHIN KAKO CO., LTD.
³⁾Celldex SL-20P, the product of NIHON SHOKUHIN KAKO CO., LTD.
⁴⁾It was felt that the solution has gotten thickness and the taste and flavor changed.

### Examples 4 to 6

Bitterness suppression agents were incorporated in 0.00370 g/100 mL quinine sulfate standard solutions (bitterness intensity 6) at the ratios as shown in Table 3 to prepare test solutions, and after that the sensory test was conducted. The results thus obtained are shown in Table 3. It is noted that as the bitterness suppression agent, commercially available methyl salicylate (Methyl salicylate Sigma Ultra, the product of SIGMA-ALDRICH CORPORATION) was used.

TABLE 3

| | | Added amount of | |
|---|---|---|---|
| | | bitterness | |
| | Kind of | suppression | |
| | bitterness | agent | Bitterness |
| | suppression agent | (ppm by weight) | intensity |
| Standard | — | — | 6 |
| Example 4 | Methyl | 0.1 | 5.5 |
| | salicylate¹⁾ | | |
| Example 5 | Methyl | 0.5 | 5.4 |
| | salicylate¹⁾ | | |
| Example 6 | Methyl | 1 | 4.8 |
| | salicylate¹⁾ | | |

¹⁾Methyl salicylate Sigma Ultra, purity 99%, the product of SIGMA-ALDRICH CORPORATION

### Examples 7 to 9

Bitterness suppression agents were incorporated in aqueous solutions containing 0.09% by weight of a commercially available catechin preparation (TEAVIGO, the product of DSM Nutritional Products GmbH, EGCg purity 90%) at the ratios as shown in Table 4 to prepare test solutions, and after that the sensory test was conducted. It is noted that as the bitterness suppression agent, the same commercial methyl salicylate as used in Examples 1 to 3 was used.

### Comparative Example 3

A test solution was prepared by the same operation as in Example 7, except for not incorporating a bitter astringency suppressing agent, and after that the sensory test was conducted. The results thus obtained are shown in Table 4.

### Comparative Example 4

A test solution was prepared by the same operation as in Example 7, except for incorporating β-cyclic oligosaccharide at the ratio as shown in Table 4 instead of methyl salicylate, and after that the sensory test was conducted. The results thus obtained are shown in Table 4.

### Comparative Example 5

A test solution was prepared by the same operation to Example 7, except for incorporating cyclic oligosaccharide at the ratio as shown in Table 4 instead of methyl salicylate, and after that the sensory test was conducted. The results thus obtained are shown in Table 4.

TABLE 4

| | | Added amount | |
|---|---|---|---|
| | | of bitterness | |
| | | suppression | |
| | Kind of | agent | |
| | bitterness | (ppm by | Bitterness |
| | suppression agent | weight) | intensity |
| Example 7 | Methyl | 0.1 | 4.5 |
| | salicylate¹⁾ | | |
| Example 8 | Methyl | 0.5 | 4.3 |
| | salicylate¹⁾ | | |
| Example 9 | Methyl | 1 | 4.0 |
| | salicylate¹⁾ | | |
| Comparative | — | — | 5.5 |
| Example 3 | | | |
| Comparative | β-Cyclodextrin²⁾ | 500 | 4.5 |
| Example 4 | | | |
| Comparative | Cyclic | 5000 | 3.2⁴⁾ |
| Example 5 | oligosaccharide³⁾ | | |

¹⁾Methyl salicylate Sigma Ultra, purity 99%, the product of SIGMA-ALDRICH CORPORATION
²⁾Celldex B-100, the product of NIHON SHOKUHIN KAKO CO., LTD.
³⁾Celldex SL-20P, the product of NIHON SHOKUHIN KAKO CO., LTD.
⁴⁾It was felt that the solution has gotten thickness and the taste and flavor changed.

From Tables 2 to 4, it found that addition of a bitterness suppression agent containing methyl salicylate as an active component enabled effective suppression of bitterness without impairing the original taste and flavor. Also, comparing Example 1 to Comparative Examples 1 and 2, and Example 7 to Comparative Example 4, it found that the bitterness suppression agent according to the invention was able to sufficiently suppress bitterness at an extremely small added amount compared to the conventional bitterness suppression agents.

### Production Example 1

### Production of Purified Catechin Preparation

Into 9,000 g of a 95% by weight aqueous solution of ethanol, 1,000 g of a commercially available catechin preparation (POLYPHENON HG, supplied by MITSUI NORIN CO., LTD.) was suspended under stirring conditions of 25° C. and 200 r/min, to which 200 g of activated carbon (KURARAY COAL GLC, the product of KURARAY CHEMICAL CO., LTD.) and 500 g of acid clay (MIZUKA-ACE #600, the product of MIZUSAWA INDUSTRIAL CHEMICALS, LTD.) were added, followed by stirring for approximately 10 minutes. Subsequently, stirring was continued for approximately 30 minutes while keeping the temperature at 25° C. Then, activated carbon, acid clay, and precipitates were filtered off using a No. 2 filter paper, and after that, the filtrate was filtered again through a 0.2 μm membrane filter. Lastly, 200 g of ion-exchange water was added to the filtrate, ethanol was distilled off at 40° C. and 3.3 kPa, and the resulting solution was concentrated under reduced pressure. Then, 750 g of the resulting solution was transferred to a stainless steel container, to which ion-exchange water was added to bring the total volume to 10,000 g. To this, 30 g of a 5% by weight aqueous solution of sodium bicarbonate was added to adjust pH to 5.5. Subsequently, under stirring conditions of 22° C. and 150 r/min, a solution prepared by dissolving 2.7 g of tannase KTFH (Industrial Grade, 500 U/g or more, the product of KIKKOMAN BIOCHEMIFA COMPANY) in 10.7 g of ion-exchange water was added, and when pH had dropped to 4.24, which occurred 30 minutes later, the enzyme reaction was terminated. After that, the stainless steel container was immersed in a hot water bath of 95° C., where it was kept at 90° C. for 10 minutes to completely deactivate the enzyme activity. Then, it was cooled to 25° C. and concentrated to give a purified catechin preparation. The content of the non-polymer catechins in the purified catechin preparation was 15% by weight, and the ratio of the gallate form in the non-polymer catechins was 46% by weight.

### Production Example 2

### Production of a Black Tea Extract

CTC black tea produced in Kenya was extracted with 90° C. ion-exchange water for 90 seconds at a bath ratio of 60. After cooling, the resulting solution was filtered through a metal mesh. The filtrate was further filtered through a No. 2 filter paper to give a black tea extract. The content of the non-polymer catechins in the black tea extract was 0.011% by weight, and the ratio of the gallate form in the non-polymer catechins was 60% by weight. Also, the solid content in the black tea extract was 0.53% by weight.

### [Measurement of the Non-Polymer Catechins]

A sample was filtered through a filter (0.8 μm), and then analyzed by the gradient method using a high performance liquid chromatograph (model SCL-10 AVP, the product of SHIMADZU CORPORATION) equipped with an Octadecyl group-introduced packed column for liquid chromatography (L-column TM ODS, a diameter of 4.6 mm×250 mm: the product of CHEMICAL EVALUATION AND RESEARCH INSTITUTE, JAPAN) at a column temperature of 35° C. Measurement was performed under the following conditions: liquid A in the mobile phase was a distilled aqueous solution containing 0.1 mol/L of acetic acid, liquid B in the mobile phase was an acetonitrile solution containing 0.1 mol/L of acetic acid, the sample input amount was 20 μL, and the UV detector wavelength was 280 nm.

### Examples 10 to 17 and Comparative Examples 6 to 11

Each component was incorporated at the ratio as shown in Table 5 to give tea drinks. These tea drinks were sterilized under the sterilization conditions as stipulated in the Food Sanitation Act (96° C. for 76 seconds) and packed in PET bottles to give packaged tea drinks. The sensory test was conducted with reference to the packaged tea drinks thus obtained. In the sensory test, with reference to the packaged tea drinks having the same content of the non-polymer catechins, a “suppression level of bitterness (Δ)” is determined by calculating a difference between the bitterness intensity of each of the packaged tea drink and the one of the packaged tea drink of Comparative Example in which only (B) methyl salicylate is not contained. This value is an index showing the effect of the bitterness suppression (Note: the same is applied to the following Example). The results thus obtained are shown in Table 5.

TABLE 5

| | | Example | | | | | | | |
|---|---|---|---|---|---|---|---|---|---|
| | | 10 | 11 | 12 | 13 | 14 | 15 | 16 | 17 |
| Component | Purified catechin preparation | 1.2 | 0.67 | 1.2 | 1.3 | 1.2 | 1.2 | 1.2 | 1.2 |
| | (g) | | | | | | | | |
| | Methyl salicylate¹⁾ | 0.01 | 0.02 | 0.02 | 0.02 | 0.05 | 0.2 | 0.5 | 1 |
| | (mg) | | | | | | | | |
| | Ion-exchange water | Balance | Balance | Balance | Balance | Balance | Balance | Balance | Balance |
| | Total (g) | 100 | 100 | 100 | 100 | 100 | 100 | 100 | 100 |
| Analytical value | (A) Non-polymer catechins (% by weight) | 0.18 | 0.10 | 0.18 | 0.20 | 0.18 | 0.18 | 0.18 | 0.18 |
| | (B) Methyl salicylate (ppm) | 0.10 | 0.20 | 0.20 | 0.20 | 0.50 | 2.00 | 5.00 | 10.0 |
| | Weight ratio (B)/(A) | 0.56 | 2.00 | 1.11 | 1.00 | 2.78 | 11.11 | 27.78 | 55.56 |
| | (·10⁻⁵) | | | | | | | | |
| | pH (20° C.) | 4.0 | 4.2 | 4.0 | 4.0 | 4.0 | 4.0 | 4.0 | 4.0 |
| Evaluation | Bitterness intensity | 5.8 | 4 | 5.5 | 5.5 | 5.3 | 4.5 | 4.5 | 4.3²⁾ |
| | Δ⁴⁾ | 0.2 | 0.5 | 0.5 | 0.5 | 0.7 | 1.5 | 1.5 | 1.7 |

| | | Comparative Example | | | | | |
|---|---|---|---|---|---|---|---|
| | | 6 | 7 | 8 | 9 | 10 | 11 |
| Component | Purified catechin preparation | 1.2 | 0.67 | 1.3 | 1.2 | 1.2 | 4.7 |
| | (g) | | | | | | |
| | Methyl salicylate¹⁾ | 0 | 0 | 0 | 0.001 | 2 | 0.02 |
| | (mg) | | | | | | |
| | Ion-exchange water | Balance | Balance | Balance | Balance | Balance | Balance |
| | Total (g) | 100 | 100 | 100 | 100 | 100 | 100 |
| Analytical value | (A) Non-polymer catechins (% by weight) | 0.18 | 0.10 | 0.20 | 0.18 | 0.18 | 0.70 |
| | (B) Methyl salicylate (ppm) | 0 | 0 | 0 | 0.01 | 20.0 | 0.20 |
| | Weight ratio (B)/(A) | 0 | 0 | 0 | 0.056 | 111.1 | 0.29 |
| | (·10⁻⁵) | | | | | | |
| | pH (20° C.) | 4.0 | 4.2 | 4.0 | 4.0 | 4.0 | 3.8 |
| Evaluation | Bitterness intensity | 6 | 4.5 | 6 | 6 | 4.3³⁾ | 9 |
| | Δ⁴⁾ | 0 | 0 | 0 | 0 | 1.7 | 0 |

¹⁾Methyl salicylate Sigma Ultra, purity 99%, the product of SIGMA-ALDRICH CORPORATION
²⁾Taste and flavor was slightly affected
³⁾Taste and flavor changed
⁴⁾Suppression level of bitterness

### Examples 18 to 20 and Comparative Examples 12 to 14

Each component was incorporated at the ratio as shown in Table 6 to give black tea drinks. These black tea drinks were sterilized under the sterilization conditions as stipulated in the Food Sanitation Act (96° C. for 76 seconds) and packed in PET bottles to give packaged black tea drinks. The sensory test was conducted with reference to the packaged black tea drinks thus obtained. The results thus obtained are shown in Table 6.

TABLE 6

| | | Example | | | Comparative Example | | |
|---|---|---|---|---|---|---|---|
| | | 18 | 19 | 20 | 12 | 13 | 14 |
| Component | Black tea extract (g) | 28.3 | 28.3 | 28.3 | 28.3 | 28.3 | 28.3 |
| | Purified catechin | 1.15 | 0.61 | 1.30 | 1.15 | 0.61 | 1.30 |
| | preparation (g) | | | | | | |
| | Methyl salicylate¹⁾ (mg) | 0.5 | 0.02 | 0.02 | 0 | 0 | 0 |
| | Antioxidant (g) | 0.057 | 0.057 | 0.057 | 0.057 | 0.057 | 0.057 |
| | Ion-exchange water | Balance | Balance | Balance | Balance | Balance | Balance |
| | Total (g) | 100 | 100 | 100 | 100 | 100 | 100 |
| Analytical | (A) Non-polymer | 0.18 | 0.1 | 0.19 | 0.18 | 0.1 | 0.19 |
| value | catechins (% by weight) | | | | | | |
| | (B) Methyl salicylate | 5 | 0.2 | 0.2 | 0 | 0 | 0 |
| | (ppm) | | | | | | |
| | Weight ratio (B)/(A) | 27.78 | 2 | 1.11 | 0 | 0 | 0 |
| | (×10⁻⁵) | | | | | | |
| | Catechin gallate ratio | 46 | 44 | 46 | 46 | 44 | 46 |
| | (% by weight) | | | | | | |
| | pH (20° C.) | 4.1 | 4.1 | 4.1 | 4.1 | 4.1 | 4.1 |
| Evaluation | Bitterness intensity | 4.7 | 4.2 | 5.7 | 6.2 | 4.7 | 6.2 |
| | Δ²⁾ | 1.5 | 0.5 | 0.5 | 0 | 0 | 0 |

¹⁾Methyl salicylate Sigma Ultra, purity 99%, the product of SIGMA-ALDRICH CORPORATION
²⁾Suppression level of bitterness

From Tables 5 and 6, it found that packaged drinks having suppressed bitterness despite containing high concentrations of the non-polymer catechins were obtained by controlling the concentration of each of (A) the non-polymer catechins and (B) methyl salicylate of the drink within a specific range.

1. A bitterness suppression method comprising incorporating methyl salicylate to a composition having a bitterness.

2. The bitterness suppression method according to claim 1, wherein a bitterness intensity of the composition having the bitterness is 7 or less based on a quinine sulfate standard solution.

3. The bitterness suppression method according to claim 1, wherein the composition having the bitterness is a food and drink.

4. The bitterness suppression method according to claim 2, wherein the composition having the bitterness is a food and drink.

5. The bitterness suppression method according to any one of claims 1 to 4, wherein an added amount of the methyl salicylate is 0.05 ppm by weight or more relative to a total weight of the composition having the bitterness.

6. A drink comprising a bitter component and 0.05 to 10 ppm by weight of methyl salicylate.

7. A drink comprising the following components (A) and (B):
(A) 0.03 to 0.6% by weight of non-polymer catechins; and
(B) 0.05 to 10 ppm by weight of methyl salicylate.

8. The drink according to claim 7, wherein a content of (A) the non-polymer catechins is 0.05 to 0.3% by weight.

9. The drink according to claim 7, wherein a content of (B) the methyl salicylate is 0.1 to 5 ppm by weight.

10. The drink according to claim 8, wherein a content of (B) the methyl salicylate is 0.1 to 5 ppm by weight.

11. The drink according to any one of claims 7 to 10, wherein a content weight ratio of (B) methyl salicylate to (A) the non-polymer catechins [(B)/(A)] is 0.4×10⁻⁵ to 0.001.

12. The drink according to any one of claims 6 to 10, wherein the drink is black tea.

13. The drink according to claim 11, wherein the drink is black tea.

14. A bitterness suppression method for a drink containing a bitter component, comprising adding 0.05 to 10 ppm by weight of methyl salicylate to the drink containing the bitter component.

15. The bitterness suppression method according to claim 14, wherein the bitter component is non-polymer catechins, and the drink contains 0.03 to 0.6% by weight of the non-polymer catechins.

16. The bitterness suppression method according to claim 14 or 15, wherein the drink is black tea.
